(19) United States
(12) Patent Application Publication
(10) Pub. No.: US 2021/0326275 A1
(43) Pub. Date: Oct. 21, 2021

(54) DYNAMIC BANDWIDTH ALLOCATION OF STORAGE SYSTEM PORTS

(71) Applicant: EMC IP Holding Company LLC, Hopkinton, MA (US)

(72) Inventors: Ananthakrishnan Anirudhan, Ernakulam (IN); Santoshkumar Konnur, Bangalore (IN); Shruti Asmita, Varanasi (IN); Prashant Malik, Bangalore (IN)

(73) Assignee: EMC IP Holding Company LLC, Hopkinton, MA (US)

(21) Appl. No.: 16/849,082

(22) Filed: Apr. 15, 2020

(51) Int. Cl. G06F 13/16; G06F 11/30; G06F 11/34; G06N 20/00

(52) U.S. Cl. CPC G06F 13/1668; G06F 11/3041; G06Q 10/10; G06N 20/00; G06F 11/349

(57) ABSTRACT

Embodiments of the present disclosure relate to controlling bandwidth allocations of storage system ports. A maximum bandwidth of one or more ports of the storage device for receiving migration data from a remote storage device are dynamically allocated based on one or more state metric of a storage device. The migration data is migrated from the remote storage device based on each port's bandwidth allocation.

### BACKGROUND

Data migration is the process of moving data from one location to another, one format to another, or one application to another. Generally, this is the result of introducing a new system or location for the data. A business driver of data migration can include an application migration or consolidation in which legacy systems are replaced or augmented by new applications that will share the same dataset. Data migrations are often started as companies moves from on-premises infrastructure and applications to cloud-based storage and applications to optimize or transform their respective companies.

### SUMMARY

One or more aspects of the present disclosure relate to controlling bandwidth allocations of storage system ports. A maximum bandwidth of one or more ports of the storage device for receiving migration data from a remote storage device are dynamically allocated based on one or more state metric of a storage device. The migration data is migrated from the remote storage device based on each port's bandwidth allocation.

In embodiments, input/output (I/O) workloads of each port can be monitored. Anticipated workloads based on the monitored workload and historical workloads for a future time interval for each port can also be determined.

In embodiments, anticipated workloads can be predicted using one or more machine learning engines comprising ingest the monitored I/O workloads and historical I/O workloads.

In embodiments, a bandwidth consumption for current and future time intervals of each port can be determined based on the workload and anticipated workloads of each port based.

In embodiments, the maximum bandwidth of each port for receiving the migration data can be dynamically allocated based on the determined bandwidth consumption.

In embodiments, performance metrics of the storage device can be monitored in response to each port's dynamically allocated maximum bandwidth for receiving the migration data.

In embodiments, the performance metrics can correspond to the storage device's response times corresponding to one or more input/output operations corresponding to the workload of the storage device.

In embodiments, a port bandwidth allocation model can be generated based on one or more of each port's current/historical dynamically allocated maximum bandwidth for receiving migration data and corresponding performance metrics of the storage device.

In embodiments, the port bandwidth allocation model for each port can be generated using one or more machine learning engines to process one or more of each port's current/historical dynamically allocated maximum bandwidth for receiving migration data and the corresponding performance metrics of the storage device

In embodiments, a random maximum bandwidth allocation for receiving the migration data can be introduced to each port. Additionally, the performance metrics of the storage device in response to the random maximum bandwidth allocation can be monitored. Further, a revised bandwidth allocation model can be generated based on data used to generate the port bandwidth allocation model for each port and the performance metrics of the storage device in response to the random maximum bandwidth allocation.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a block diagram of an example a storage system in accordance with example embodiments disclosed herein.

FIGS. 2-2A illustrate block diagrams of a port controller system in accordance with example embodiments disclosed herein.

FIG. 3 is a communication flow diagram of data storage migration in accordance with example embodiments disclosed herein.

FIG. 4 is a flow diagram of a method for resource management in accordance with example embodiments disclosed herein.

### DETAILED DESCRIPTION

Today, businesses generate vast amounts of data. To stay competitive, these businesses must maximize the value they extract from the data. Success depends increasingly on choosing optimal environments for data workloads and ensuring the data is stored efficiently and accessibly. Accordingly, businesses may require moving data workloads and storage to new systems. Businesses can implement one or more data migration techniques to move the data. Data migration can include online migration and/or offline migration techniques. Online migration includes moving data across a network (e.g., the Internet) or a private/dedicated wide area network (WAN) connection. Offline migration includes transferring data via a physical storage appliance. In many circumstances, data migration involves heterogeneous storage systems (e.g., moving data between different vendor storage systems).

Businesses can use a data migration tool configured to assist with migrating data between heterogeneous storage systems. Many of these tools perform hot pull operations that retrieve data from a source storage system to a target storage system (e.g., the new storage system). In some circumstances, the target storage system may be used by a business for its day-to-day business operations. As such, host input/output (I/O) operations and the hot pull operations may require shared access to the bandwidth of one or more of the same host adapter (HA) ports. During operating hours of a business, the hot pull operations are generally run as a background process to ensure that data migration operations do not affect the target storage system's performance. Specifically, host I/O operations corresponding to daily business hours are afforded a higher priority over data migration operations.

To ensure bandwidth resources are available to process such priority host I/O operations, current data migration tools may set a static bandwidth threshold (i.e., ceiling) allocation for data migration at each HA port. As such, the ceiling defines a percentage of each port's bandwidth available for migrating data. For example, a first portion of each HA port's bandwidth can be allocated for host I/O operations and a second portion of the bandwidth can be allocated for data migration. In some circumstances, host I/O operations may not require the full bandwidth of the first portion. However, the current data migration tools are unable to take advantage of and reallocate the unused bandwidth allocated for host I/O operations. Specifically, the current data migration tools cannot reallocate the unused bandwidth for data migration due to the statically set data migration bandwidth ceiling.

Embodiments of the present disclosure relate to dynamically adjusting port bandwidth allocations based on current and anticipated storage system state metrics (e.g., I/O load, CPU load/performance, and I/O operation processing rates). For example, embodiments can dynamically calculate each HA port's bandwidth allocations based on a storage system's I/O load and central processing unit (CPU) load. The embodiments can use one or more machine learning (ML) techniques that ingest storage system loads and CPU loads to calculate the bandwidth allocations. The ML techniques can measure performance of the storage system based on the calculated bandwidth allocation to optimize future calculations. Accordingly, the ML techniques can include a reinforcement learning ML technique that is configured to learn and optimize calculations based on previous calculations and corresponding performances resulting from those previous calculations.

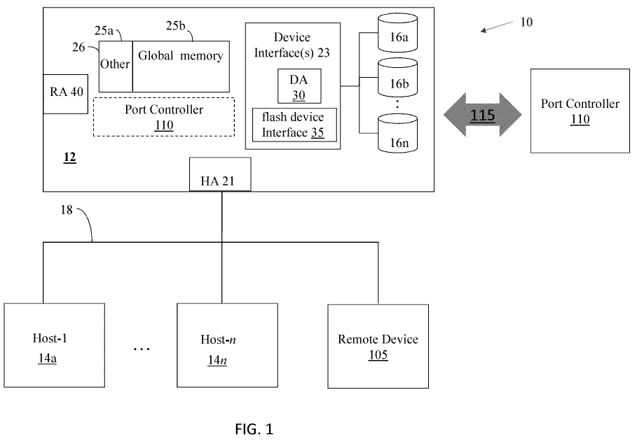

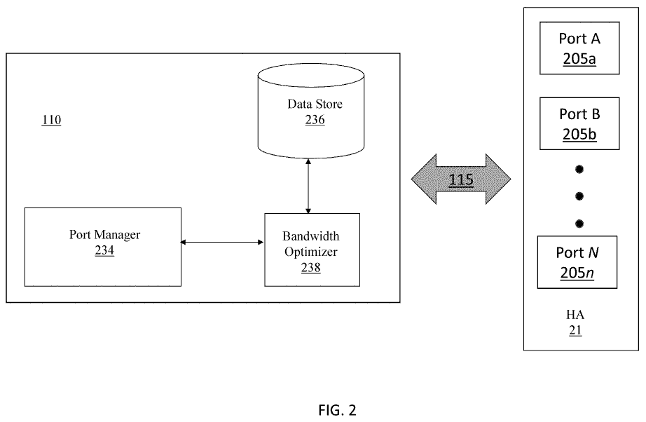

Referring to FIG. 1, a data migration system 10 includes a data storage system 12 connected to host systems 14a-n and a remoter device 105 (e.g., a source storage system) through communication medium 18. In embodiments, the hosts 14a-n can access the data storage system 12, for example, to perform input/output (I/O) operations or data requests. The communication medium 18 can be any one or more of a variety of networks or other type of communication connections as known to those skilled in the art. The communication medium 18 may be a network connection, bus, and/or other type of data link, such as a hardwire or other connections known in the art. For example, the communication medium 18 may be the Internet, an intranet, network (including a Storage Area Network (SAN)) or other wireless or other hardwired connection(s) by which the host 14a-n can access and communicate with the data storage system 12. The hosts 14a-n can also communicate with other components included in the system 10 via the communication medium 18.

Each of the hosts 14a-n and the data storage system 12 can be connected to the communication medium 18 by any one of a variety of connections as may be provided and supported in accordance with the type of communication medium 18. The processors included in the hosts 14a-n may be any one of a variety of proprietary or commercially available single or multi-processor system, such as an Intel-based processor, or other type of commercially available processor able to support traffic in accordance with each embodiment and application.

It should be noted that the examples of the hardware and software that may be included in the data storage system 12 are described herein in more detail and can vary with each embodiment. Each of the hosts 14a-n and data storage system 12 can all be located at the same physical site or can be in different physical locations. Examples of the communication medium 18 that can be used to provide the different types of connections between the host computer systems and the data storage system of the system 10 can use a variety of different communication protocols such as SCSI, Fibre Channel, iSCSI, and the like. Some or all the connections by which the hosts 14a-n and the data storage system 12 can be connected to the communication medium 18 may pass through other communication devices, such switching equipment that may exist such as a phone line, a repeater, a multiplexer or even a satellite.

Each of the hosts 14a-n can perform different types of data operations in accordance with different types of tasks. In embodiments, any one of the hosts 14a-n may issue a data request to the data storage system 12 to perform a data operation. For example, an application executing on one of the hosts 14a-n can perform a read or write operation resulting in one or more data requests to the data storage system 12.

It should be noted that although the storage system 12 is illustrated as a single data storage system, such as a single data storage array, storage system 12 may also represent, for example, multiple data storage arrays alone, or in combination with, other data storage devices, systems, appliances, and/or components having suitable connectivity, such as in a SAN, in an embodiment using the embodiments herein. It should also be noted that an embodiment may include data storage arrays or other components from one or more vendors. In subsequent examples illustrated the embodiments herein, reference may be made to a single data storage array by a vendor, such as by DELL Technologies of Hopkinton, Mass. However, as will be appreciated by those skilled in the art, the embodiments herein are applicable for use with other data storage arrays by other vendors and with other components than as described herein for purposes of example.

The data storage system 12 may be a data storage array including a plurality of data storage devices 16a-n. The data storage devices 16a-n may include one or more types of data storage devices such as, for example, one or more disk drives and/or one or more solid state drives (SSDs). An SSD is a data storage device that uses solid-state memory to store persistent data. An SSD using SRAM or DRAM, rather than flash memory, may also be referred to as a RAM drive. SSD may refer to solid state electronics devices as distinguished from electromechanical devices, such as hard drives, having moving parts. Flash devices or flash memory based SSDs are one type of SSD that contains no moving parts. The embodiments described herein can be used in an embodiment in which one or more of the devices 16a-n are flash drives or devices. More generally, the embodiments herein may also be used with any type of SSD although following paragraphs can refer to a particular type such as a flash device or flash memory device.

The data storage system 12 may also include different types of adapters or directors, such as an HA 21 (host adapter), RA 40 (remote adapter), and/or device interface 23. Each of the adapters HA 21, RA 40 may be implemented using hardware including a processor with local memory with code stored thereon for execution in connection with performing different operations. The HA 21 may be used to manage communications and data operations between one or more host systems 14a-n and the global memory (GM) 25b. In an embodiment, the HA 21 may be a Fibre Channel Adapter (FA) or another adapter which facilitates host communication. The HA 21 may be characterized as a front-end component of the data storage system 12 which receives a request from one or more of the hosts 14a-n. The data storage system 12 can include one or more RAs (e.g., RA 40) that may be used, for example, to facilitate communications between data storage arrays. The data storage system 12 may also include one or more device interfaces 23 for facilitating data transfers to/from the data storage devices 16a-n. The data storage interfaces 23 may include device interface modules, for example, one or more disk adapters (DAs) 30 (e.g., disk controllers), flash drive interface 35, and the like. The DA 30 can be characterized as a back-end component of the data storage system 12 which interfaces with the physical data storage devices 16a-n.

One or more internal logical communication paths may exist between the device interfaces 23, the RAs 40, the HAs 21, and the memory 26. An embodiment, for example, may use one or more internal busses and/or communication modules. For example, the global memory 25b may be used to facilitate data transfers and other communications between the device interfaces, HAs and/or RAs in a data storage array. In one embodiment, the device interfaces 23 may perform data operations using a cache that may be included in the global memory 25b, for example, when communicating with other device interfaces and other components of the data storage array. The other portion 25a is that portion of memory that may be used in connection with other designations that may vary in accordance with each embodiment.

The data storage system as described in this embodiment, or a device thereof, such as a disk or aspects of a flash device, should not be construed as a limitation. Other types of commercially available data storage systems, as well as processors and hardware controlling access to these devices, may also be included in an embodiment.

Host systems 14a-n provide data and access control information through channels to the storage system 12, and the storage system 12 may also provide data to the host systems 14a-n also through the channels. The host systems 14a-n do not address the drives or devices 16a-n of the storage systems directly, but rather access to data can be provided to one or more host systems 14a-n from what the host systems view as a plurality of logical devices or logical volumes (LVs). The LVs may or may not correspond to the actual physical devices or drives 16a-n. For example, one or more LVs may reside on a single physical drive or multiple drives. Data in a single data storage system, such as a single data storage system 12, may be accessed by multiple hosts allowing the hosts to share the data residing therein. The HA 21 may be used in connection with communications between a data storage system 12 and one or more of the host systems 14a-n. The RA 40 may be used in facilitating communications between two data storage arrays. The DA 30 may be one type of device interface used in connection with facilitating data transfers to/from the associated disk drive(s) 16a-n and LV(s) residing thereon. A flash device interface 35 may be another type of device interface used in connection with facilitating data transfers to/from the associated flash devices and LV(s) residing thereon. It should be noted that an embodiment may use the same or a different device interface for one or more different types of devices than as described herein.

The device interface, such as a DA 30, performs I/O operations on a drive 16a-n. In the following description, data residing on an LV may be accessed by the device interface following a data request in connection with I/O operations that other directors originate. Data may be accessed by LV in which a single device interface manages data requests in connection with the different one or more LVs that may reside on a drive 16a-n. For example, a device interface may be a DA 30 that accomplishes the foregoing by creating job records for the different LVs associated with a device. These different job records may be associated with the different LVs in a data structure stored and managed by each device interface.

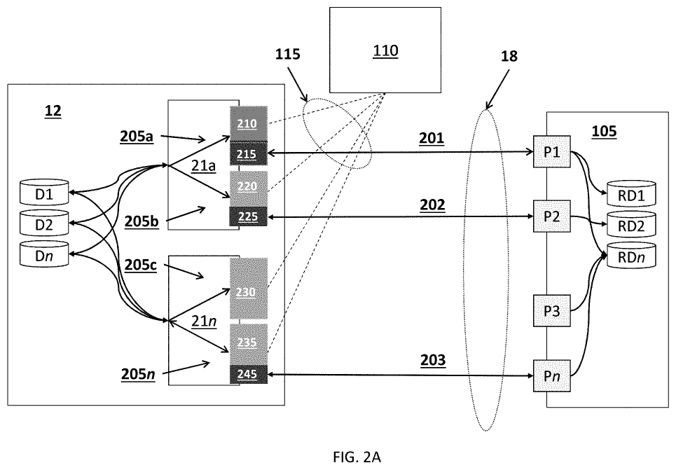

A port controller 110 (e.g., a data migration tool) can dynamically control bandwidth allocations of each HA data port (e.g., ports 205a-n if FIG. 2). For example, each data port can receive I/O operations from the hosts 14a-n and migration data from a remote device 105 (e.g., a source data storage system of the migration data). As such, the port controller 110 is configured to dynamically allocate portions of each port's I/O operational bandwidth (e.g., elements 210, 220, 230, and 235 of FIG. 2A) and migration data bandwidth (e.g., elements 215, 225, and 245 of FIG. 2A), respectively, as described in greater detail herein. In embodiments, each HA data port (e.g., ports 205a-n of FIG. 2A) can include one or more of Fibre channel (FC) ports, ISCSI Ports (e.g., ethernet), and NVMe Ports.

The port controller 110 may communicate with the data storage system 12 and each port 205a-n using a communication connection 115. In one embodiment, the port controller 110 may communicate with the data storage system 12 through three different connections, a serial port, a parallel port and using a network interface card, for example, with an Ethernet connection. Using the Ethernet connection, for example, a memory management processor may communicate directly with DA 30 and HA 21 within the data storage system 12. In other embodiments, the port controller 105 may be included within one of the hosts 14a-n. Although the port controller 110 is depicted as an element external to the storage system 12, it should be noted that the port controller 110 can optionally exist within the data storage system 12.

Referring to FIGS. 2-2A, a port controller 110 can be communicatively couples to one or more host adapters (HA) 21a-n of storage device 12. The port controller 110 can include elements 100 (e.g., software and hardware elements). It should be noted that the port controller 110 may be any one of a variety of commercially available processors, such as an Intel-based processor, and the like. In embodiments, the port controller 110 can be a parallel processor such as a graphical processing unit (GPU). Although what is described herein shows details of software and/or hardware elements that may reside in the port controller 110, all or portions of the illustrated components may also reside elsewhere such as on, for example, HA 21.

The port controller 110 can include a port manager 234 that controls data migration from data stored on remote disks RD1-RDn of remote device 105 to disks D1-Dn of storage device 12. To that end, the port controller can include a port manger 234 that monitors a runtime environment of the storage device 12. In embodiments, the port manager 234 can monitor HA port data traffic via the communications medium 115. In embodiments, the port manager 234 monitors I/O workloads at each HA port 205a-n. The I/O workloads can correspond to I/O operations received from hosts 14a-n. Further, the port manager 234 can monitor and generate state metrics of the storage 12. The state metrics can correspond to I/O loads, CPU loads/performances, and I/O operation processing rates, amongst other metrics of the storage device 12. For example, the port manager 234 can take snapshots of the state metrics at random or periodic points in time. The port manager 234 can further store the snapshots in data store 236.

Due to the continuous nature of state metric values and numbers of possible storage device states, the storage space of the data store 236 can be consumed quickly. To minimize storage requirements, the port manager 234 can represent each storage state as a state tuple of elements. Each tuple element can be a value representing a single state metric. Further, each value can represent a performance class or load class of each state metric. For example, each class can represent a range of state metric values of state metrics such as I/O processing rate, CPU load, and I/O load metrics. In such embodiments, each snapshot of I/O processing rates can be defined by one (1) of ten (10) load classes (e.g., 0-9), with each load class representing a range of processing rates in mb/s; CPU usages can be defined by 1 of three (3) performance classes (e.g., 1-3), with each class representing a range of % CPU usage values; and I/O loads can be defined by 1 of 3 load classes (e.g., 1-3), with each class representing a range I/O operations per second (IOPS) values. The snapshots can be stored as a unique storage state, e.g., as Table 1 illustrated below. As illustrated, the state table defines state metric tuples and their values.

TABLE 1

| | | I/O Load | CPU | CPU | | IOPS |
|---|---|---|---|---|---|---|
| I/O RATE | | Class | USAGE | CLASS | IOPS | CLASS |
| <10 | mb/s | 0 | 0-30% | 1 | <50 | 1 |
| 10-20 | mb/s | 1 | 30-70% | 2 | 50-500 | 2 |
| 20-30 | mb/s | 2 | 70-100% | 3 | >1000 | 3 |
| 30-40 | mb/s | 3 | | | | |
| 40-50 | mb/s | 4 | | | | |
| 50-60 | mb/s | 5 | | | | |
| 60-70 | mb/s | 6 | | | | |
| 70-80 | mb/s | 7 | | | | |
| 80-90 | mb/s | 8 | | | | |
| >90 | mb/s | 9 | | | | |

Accordingly, each state tuple element can include a value from each of the I/O load class, CPU class, and IOPS class from Table 1. For instance, a snapshot represented as state tuple ‘512’ represents a storage device having I/O processing rate of 50-60 mb/s, 0-30% CPU usage, and <50 IOPS during the time associated with the snapshot.

To facilitate monitoring of the storage device 12, the port manager 12 can identify one or more device pairs (e.g., pairs between ports 205a-n and remote device ports P1-Pn). For example, the port manager 12 can issue one or more discovery messages using a discovery protocol to identify the device pairs. In embodiments, the port manager 234 can logically associate each port 205a-n with predetermined data size units (e.g., 128 KB units). The port manager 234 can further associate each port 205a-n unit with a storage track having the same unit size of, e.g., disks D1-Dn. Using the association, the port manager 234 can monitor workloads at a track level of each storage disk D1-Dn.

The port manager 12 can further identify communication paths 201-203 between the storage device 12 and the remote device 105 over the communication medium 18 using the discovery messages. Accordingly, the port manager 234 can activate data migration sessions via one or more of the identified communication paths 201-203 based on one or more data migration schedules (e.g., data migration windows) and one or more migration models as described in greater detail herein.

Using one or machine learning (ML) techniques, a bandwidth optimizer 238 can generate one or more migration models using the monitored I/O workloads and the state metrics stored in the data store 236. In embodiments, the optimizer 238 can use a recurring neural network (RNN) to analyze historical and current I/O workloads and state metrics to generate and store the migration models in the data store 236. In embodiments, the RNN can be a Long Short-Term Memory (LSTM) network. The migration models can provide information related to anticipated host I/O workloads, anticipated state metrics, and corresponding port bandwidth allocations (e.g., bandwidth allocations 210, 215, 220, 225, 230, 235, 245). Further, the bandwidth optimizer 238 can associate each migration model to a runtime category. Each runtime category can identify a time period corresponding to storage device activities. For example, time periods can be defined as one or more of a daily time period, day of week, and week (e.g., work hours, off-hours, business days, weekends, and holidays). As such, the port manager 234 can provide migration models that anticipate workloads and storage system state metrics during any one of the runtime categories. Using the migration models, the optimizer 238 can generate the migration schedules.

Based on a time of day, the optimizer 238 can identify a migration model that the port manager 234 can use to dynamically control HA port bandwidth allocations. Using the identified migration model, the port manager 234 can dynamically adjust bandwidth allocations for either host I/O operations or data migration. Further, the optimizer 238 can monitor one or more performance parameters of the storage device 12 resulting from the port manager's 234 use of the identified migration model. The performance parameters can include one or more of I/O processing rates and data migration rates. The performance parameters can by a performance value stored in a Q-table (or Q-matrix).

Using a ML engine such as a reinforcement learning engine, the optimizer 238 can generate the Q-table (or Q-matrix). The Q-table can define the performance value as a function of a storage device state and a port bandwidth allocation (e.g., each port's data migration bandwidth allocation). An example Q-table is represented below in Table 2.

TABLE 2

| | Migration Bandwidth Ceilings | | | | | |
|---|---|---|---|---|---|---|
| States | 10 | 20 | . . . | 80 | 90 | 100 |
| 021 | 38499.6 | 15659.41 | . . . | 28559.2 | 201600 | 3299.05 |
| 111 | 919100 | 202500.05 | . . . | 50399.8 | 166440 | 23919.4 |
| 011 | 19199.9 | 28439.724 | . . . | 72750 | 57119.2 | 759.99 |
| . . . | . . . | . . . | . . . | . . . | . . . | . . . |
| 613 | 5266805 | 24364014 | . . . | 2710232 | 1032241 | 3782623 |
| 221 | 210900 | 265319.52 | . . . | 114540 | 443520 | 67940 |
| 011 | 19199.9 | 28439.724 | . . . | 72750 | 57119.2 | 10239.8 |

For example, the optimizer 238 measures the performance of the storage device 12 in response to every adjustment of each port's bandwidth allocation. The optimizer 238 updates the Q-table using the performance measurements.

Accordingly, for any given state, the port manager 234 can allocate each port's bandwidth to data migration operations based on a performance value associated with each bandwidth allocation. In other words, the port manager 234 dynamically allocates bandwidth resulting in the most optimal storage device performance as defined by the Q-table.

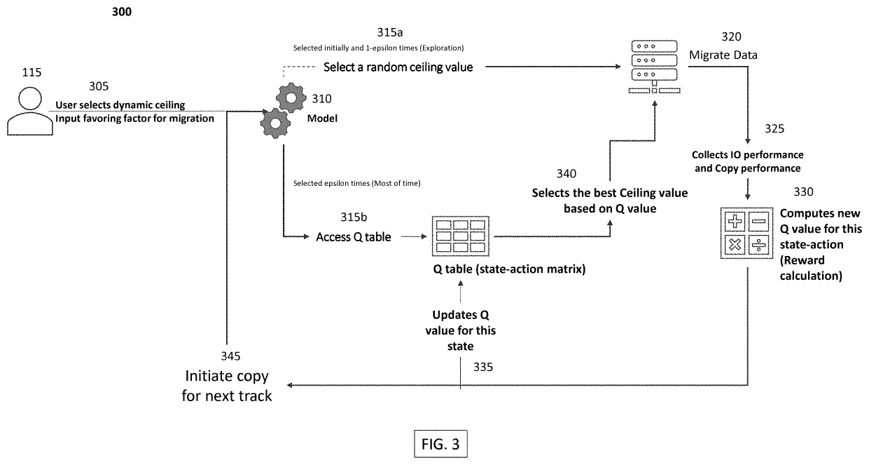

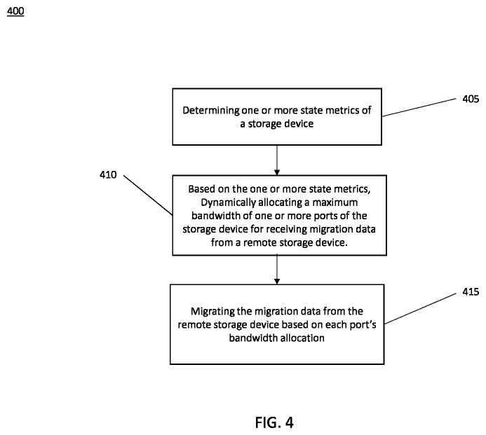

FIGS. 3-4 illustrate methods and/or flow diagrams in accordance with this disclosure. For simplicity of explanation, each method is depicted and described as a series of acts. However, acts in accordance with this disclosure can occur in various orders and/or concurrently, and with other acts not presented and described herein. Furthermore, not all illustrated acts may be required to implement each method in accordance with the disclosed subject matter.

Referring to FIG. 3, a method 300 can be executed by port controller 110 of FIG. 1. At 305, the port controller can receive an initial dynamic bandwidth ceiling value for data migration. During a first run of the method 300, the controller 110, at 315a, can generate a random data migration bandwidth ceiling value. However, during subsequent runs of the method 300, the method 300 can include, at 315a, using a randomly generated ceiling value or selecting, at 315b, a ceiling value from a Q-table. In embodiments, the method 300, at 315a-b can include making the selection based on an epsilon rate. For example, the method 300 can include selecting the ceiling value from the Q-table at a frequency corresponding to the epsilon rate and generating a random ceiling value correspond to one minus the epsilon rate (or vice versa). The method 300, at 320, can include migrating data from the remote device 105. In embodiments, each run of the method 300 can include migrating only a single track of data from the remote device 105. At 325, the method 300 can include measuring and collecting I/O performance metrics and data migration performance metrics (e.g., copy performance) of the storage device 12. Using the collected performance metrics, the method 300, at 330, can include computing a performance value (e.g., Q-value) that is a function of the storage device's state (e.g., as defined by a state tuple described above) and the implemented ceiling value. The method 300, at 335, can include updating the Q-table with the computed Q-value. At 345, the method 300 can include selecting a next track of data to migrate to the storage device 12 from the remote device 105.

It should be noted that the method 300 can be performed according to any of the embodiments described herein, known to those skilled in the art, and/or yet to be known to those skilled in the art.

Referring to FIG. 4, in embodiments, a method 400 can be executed by a port controller (e.g., the port controller 110 of FIG. 1). At 405, the method 400 can include determining one or more state metrics of a storage device. The method 400, at 410, can also include dynamically allocating a maximum bandwidth of one or more ports of the storage device for receiving migration data from a remote storage device based on the one or more state metrics. At 415, the method 400 can further include migrating the migration data from the remote storage device based on each port's bandwidth allocation.

It should be noted that the method 400 can be performed according to any of the embodiments described herein, known to those skilled in the art, and/or yet to be known to those skilled in the art.

The above-described systems and methods can be implemented in digital electronic circuitry, in computer hardware, firmware, and/or software. The implementation can be as a computer program product. The implementation can, for example, be in a machine-readable storage device, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the concepts described herein by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random-access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described embodiments can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described embodiments can be implemented in a distributed computing system that includes a back-end component. The back-end component can, for example, be a data server, a middleware component, and/or an application server. The above described embodiments can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

The transmitting device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®.

Comprise, include, and/or plural forms of each are open ended and include the listed parts and can include additional parts that are not listed. And/or is open ended and includes one or more of the listed parts and combinations of the listed parts.

One skilled in the art will realize the concepts described herein may be embodied in other specific forms without departing from the spirit or essential characteristics thereof. The foregoing embodiments are therefore to be considered in all respects illustrative rather than limiting of the concepts described herein. Scope of the concepts is thus indicated by the appended claims, rather than by the foregoing description, and all changes that come within the meaning and range of equivalency of the claims are therefore intended to be embraced therein.

1. An apparatus comprising a memory and at least one processor configured to:
determine one or more state metrics of a storage array;
represent each state of the storage array a state tuple of elements, wherein each tuple element includes a value representing a single state metric;
dynamically allocate a maximum bandwidth of one or more ports of the storage device for receiving migration data from a remote storage device based on the one or more state metrics; and
migrate the migration data from the remote storage device based on each port's bandwidth allocation.

2. The apparatus of claim 1 further configured to determine the one or more state metrics by:
monitoring input/output (I/O) workloads of each port; and
determining anticipated workloads based on the monitored workload and historical workloads for a future time interval for each port.

3. The apparatus of claim 2 further configured to predict anticipated workloads using one or more machine learning engines configured to ingest the monitored I/O workloads and historical I/O workloads.

4. The apparatus of claim 2 further configured to determine a bandwidth consumption for current and future time intervals of each port based on the workload and anticipated workloads of each port based.

5. The apparatus of claim 4 further configured to dynamically allocate the maximum bandwidth of each port for receiving the migration data based on the determined bandwidth consumption.

6. The apparatus of claim 5 further configured to monitor performance metrics of the storage device in response to each port's dynamically allocated maximum bandwidth for receiving the migration data.

7. The apparatus of claim 6, wherein the performance metrics corresponds to the storage device's response times corresponding to one or more input/output operations corresponding to the workload of the storage device.

8. The apparatus of claim 7 further configured to generate a port bandwidth allocation model based on one or more of each port's current/historical dynamically allocated maximum bandwidth for receiving migration data and corresponding performance metrics of the storage device.

9. The apparatus of claim 8 further configured to generate the port bandwidth allocation model for each port using one or more machine learning engines to process one or more of each port's current/historical dynamically allocated maximum bandwidth for receiving migration data and the corresponding performance metrics of the storage device.

10. The apparatus of claim 9 further configured to:
introduce to each port a random maximum bandwidth allocation for receiving the migration data;
monitor the performance metrics of the storage device in response to the random maximum bandwidth allocation; and
generate a revised bandwidth allocation model based on data used to generate the port bandwidth allocation model for each port and the performance metrics of the storage device in response to the random maximum bandwidth allocation.

11. A method comprising:
determining one or more state metrics of a storage array;
represent each state of the storage array a state tuple of elements, wherein each tuple element includes a value representing a single state metric;
dynamically allocating a maximum bandwidth of one or more ports of the storage device for receiving migration data from a remote storage device based on the one or more state metrics; and
migrating the migration data from the remote storage device based on each port's bandwidth allocation.

12. The method of claim 11 further comprising determine the one or more state metrics by:
monitoring input/output (I/O) workloads of each port; and
determining anticipated workloads based on the monitored workload and historical workloads for a future time interval for each port.

13. The method of claim 12 further comprising predicting anticipated workloads using one or more machine learning engines comprising ingest the monitored I/O workloads and historical I/O workloads.

14. The method of claim 12 further comprising determining a bandwidth consumption for current and future time intervals of each port based on the workload and anticipated workloads of each port based.

15. The method of claim 14 further comprising dynamically allocating the maximum bandwidth of each port for receiving the migration data based on the determined bandwidth consumption.

16. The method of claim 15 further comprising monitoring performance metrics of the storage device in response to each port's dynamically allocated maximum bandwidth for receiving the migration data.

17. The method of claim 16, wherein the performance metrics corresponds to the storage device's response times corresponding to one or more input/output operations corresponding to the workload of the storage device.

18. The method of claim 17 further comprising generating a port bandwidth allocation model based on one or more of each port's current/historical dynamically allocated maximum bandwidth for receiving migration data and corresponding performance metrics of the storage device.

19. The method of claim 18 further comprising generating the port bandwidth allocation model for each port using one or more machine learning engines to process one or more of each port's current/historical dynamically allocated maximum bandwidth for receiving migration data and the corresponding performance metrics of the storage device.

20. The method of claim 19 further comprising:
introducing to each port a random maximum bandwidth allocation for receiving the migration data;
monitoring the performance metrics of the storage device in response to the random maximum bandwidth allocation; and
generating a revised bandwidth allocation model based on data used to generate the port bandwidth allocation model for each port and the performance metrics of the storage device in response to the random maximum bandwidth allocation.
